(19) United States
(12) Patent Application Publication
(10) Pub. No.: US 2004/0111592 A1
(43) Pub. Date: Jun. 10, 2004

(54) Microprocessor performing pipeline processing of a plurality of stages

(75) Inventors: Chuma Nagao, Tokyo (JP); Hiroshi Ueki, Tokyo (JP)

Correspondence Address: BURNS, DOANE, SWECKER & MATHIS, L.L.P., P.O. Box 1404, Alexandria, VA, 22313-1404, US

(73) Assignee: Renesas Technology Corp.

(21) Appl. No.: 10/445,831

(22) Filed: May 28, 2003

(30) Foreign Application Priority Data
Dec. 6, 2002 (JP) 2002-355311

(51) Int. Cl. G06F 9/44

(52) U.S. Cl. 712/235

(57) ABSTRACT

A microprocessor is provided with two queue buffers, one for storing prefetched non branch instructions and the other for storing prefetched branch target instructions, and a plurality of process stages. The process stages are divided into one last process stage and other process stages those form two different paths. Non branch instructions are processed in one path and branch target instructions are processed in other path. The paths are changed based on whether branch condition is met or not.

### BACKGROUND OF THE INVENTION

1) Field of the Invention

The present invention relates to a microprocessor that performs pipeline processing of a plurality of stages and has prefetch and pipeline processing functions.

2) Description of the Related Art

Many modern processors have a pipelined architecture to increase instruction throughput. Such microprocessors employ what is called a delayed branch method in order to process conditional branch instructions efficiently.

A conditional branch instruction determines whether or not a branch is implemented based on a conditional flag reflecting the result of executing a calculate instruction, a transfer instruction, or the like. Delayed branch is a method of eliminating a useless blank slot by inserting, in the delay slot, an instruction residing at an address subsequent to a branch instruction. By using this method, performance of a processor can be substantially improved (see Japanese Laid-Open Patent Publication H4-127237).

Let us assume a pipeline process that involves three operational stages, namely, a first stage of fetching and decoding an instruction, a second stage of address generation and reading from memory, and a third stage of calculation and writing to memory. These three stages are shown as ST0, ST1 and ST2, respectively, in FIG. 16. Let us further assume that in this setup a conditional branch instruction (cbr) process is carried out immediately after a calculate instruction (cmp) that updates a condition flag. In the pipeline process, at the third step, after conditional decision of conditional branch instruction (cbr) subsequent to the execution of the calculate instruction, a branch target or non branch target instruction is fetched. This causes two empty cycle slots (i.e., two delay slots).

Therefore, by employing the delayed branch method in the above case, the efficiency of the microprocessor can be maximized if the instruction next to conditional branch instruction can be put into the delay slot when the branch condition is not met, and the branch target instruction of cbr can be put into the delay slot when the branch condition is met.

However, in order to employ delayed branch method, a built-in branch predicting circuit that predicts if the branch condition will be met or not during decoding of conditional branch instruction is required.

This approach of branch prediction has been used in conventional art and involves predicting whether or not branching will take place, based on the branching pattern so far, and proceeding to a branch process or a non-branch process before the result of branch judgment is obtained. For instance, as a means of branch prediction, a history table in which each branch target address is associated with an instruction that is previously executed is provided in the microprocessor (see Japanese Patent Laid-Open Publication Nos. H1-239638 and H4-112327).

However, depending on the application area, the size of the prediction table has to be in the order of 4 Kbits in order to obtain a hit ratio of 90-95%. The prediction table of this size translates to a larger circuitry and larger silicon chip area, both of which are disadvantageous. Further, having a built-in branch predicting circuit, which alters the speed of the microprocessor depending on the program execution history, is not a welcome feature in cases where realtime application is intended that require disaster estimation.

### SUMMARY OF THE INVENTION

It is an object of the present invention to at least solve the problems in the conventional technology.

The microprocessor according to one aspect of the present invention comprises a memory for storing instructions; a first queue buffer and a second queue buffer, wherein the first queue buffer stores non branch instructions from among the instructions prefetched from the memory and the second queue buffer stores branch target instructions from among the instructions prefetched from the memory; a plurality of process stages that perform pipeline processing, wherein the process stages prior to a last process stage being arranged in a first path and a second path; a first changeover unit that judges if a branch condition of a branch instruction is met or not and, based on the judgment outcome selects any one of the first path and the second path for pouring the contents to the last process stage; a second changeover unit that, based on the judgment outcome, switches the connection of the first queue buffer and the second queue buffer with the first path and the second path.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic diagram of a microprocessor according to a first embodiment of the present invention,

FIG. 2 is a block diagram of the internal structure of a central processing unit in the microprocessor according to the first embodiment,

FIG. 3 is a time chart that explains the transactions between a code interface circuit and a code memory area,

FIG. 4 is a sample program stored in the code memory area,

FIG. 5 is a drawing that explains a pipeline action when a branch condition of a conditional branch instruction is met, and the changed timing of a branch/non branch judgment signal Sd and a changeover signal Sa,

FIG. 6 is a drawing that explains a pipeline action when a branch condition of a conditional branch instruction is not met, and the changed timing of the branch/non branch judgment signal Sd and the changeover signal Sa,

FIG. 7 is a schematic diagram of a microprocessor according to a second embodiment of the present invention,

FIG. 8 is a drawing that explains the operation of the microprocessor according to a second embodiment,

FIG. 9 is a schematic diagram of a microprocessor according to a third embodiment of the present invention,

FIG. 10 is a block diagram that shows the internal structure of a CPU in the microprocessor according to the third embodiment,

FIG. 11 is a drawing that explains the operation of the microprocessor according to the third embodiment,

FIG. 12 is a schematic diagram of a microprocessor according to a fourth embodiment of the present invention,

FIG. 13 is a schematic diagram of a microprocessor according to a fifth embodiment of the present invention,

FIG. 14 is a drawing that explains about a limit setting signal,

FIG. 15 is a schematic diagram of a microprocessor according to a seventh embodiment of the present invention, and

FIG. 16 is a drawing that shows a conventional microprocessor.

### DETAILED DESCRIPTION

Exemplary embodiments of the microprocessor according to the present invention are explained with reference to the accompanying drawings.

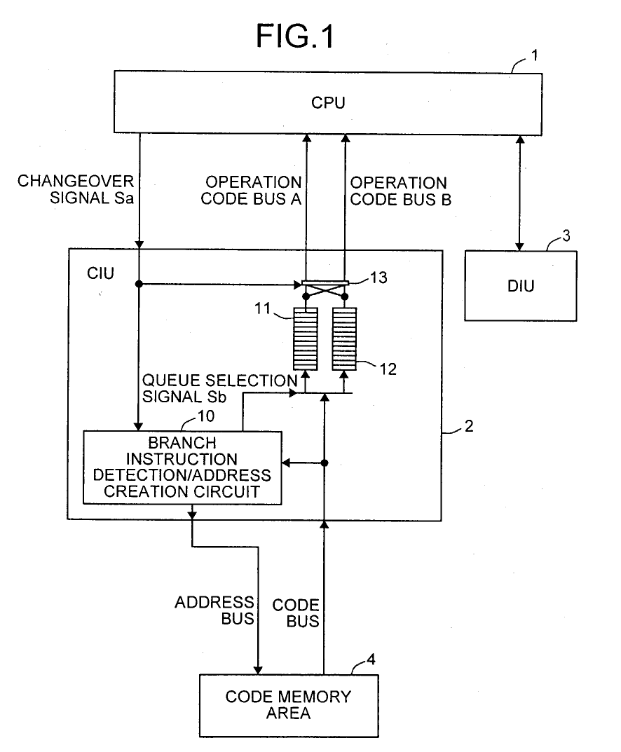

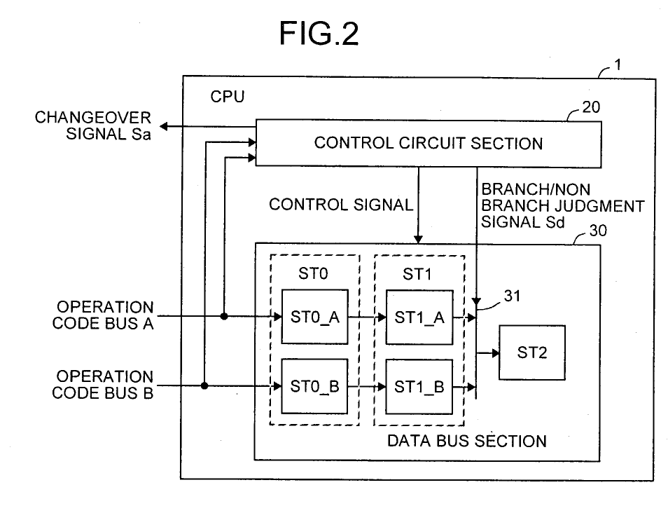

FIG. 1 is a schematic diagram of the microprocessor according to the first embodiment. FIG. 2 is the internal structure of the CPU shown in FIG. 1.

The microprocessor in FIG. 1 includes a central processing unit (CPU) 1, a code interface circuit (CIU) 2 that is an instruction cache area (bus interface circuit), a data interface circuit (DIU) 3 that is a data cache area (bus interface circuit), and a code memory area 4 which is the main memory area where series of instructions of various programs are stored. Operation code bus A and operation code bus B connect central processing unit 1 and the code interface circuit 2. In FIG. 1, a bus interface unit having a Harvard architecture is split into the code interface circuit 2 and the data interface circuit 3. However, the bus interface unit can be a unified cache area where both codes and data can be managed.

The code interface circuit 2 includes a branch instruction detection/address creation circuit 10, two types of queue buffers 11 and 12, and a changeover switch 13 that switches the output from the queue buffers 11 and 12 between the operation code buses A and B.

The queue buffers 11 and 12 store a plurality of instructions (codes) prefetched, via a code bus, from the code memory area 4. Not shown input pointer and output pointer write to and read from the queue buffers 11 and 12 the instructions prefetched from the code memory area 4.

The branch instruction detection/address creation circuit 10 detects if a conditional branch instruction is present in the code bus or not. If no branch instruction is found, the branch instruction detection/address creation circuit 10 increments a not shown program counter as needed and creates an address. If branch instructions are detected, the branch instruction detection/address creation circuit 10 decodes the branch instructions, from the information obtained by decoding, creates branch target addresses of the branch instructions, and outputs these addresses, via an address bus, to the code memory area 4. Further, the branch instruction detection/address creation circuit 10 creates a queue selection signal Sb that is required to switch the selection to input sides of the queue buffers 11 and 12 based on a changeover signal Sa input from the central processing unit 1 and a not shown branch instruction detection signal Sc (that detects a conditional branch instruction from the code bus). The branch instruction detection/address creation circuit 10 then outputs the created queue selection signal Sb to the queue buffers 11 and 12. The instruction on the code bus goes to any one of the queue buffers 11 and 12 depending on the status of the queue selection signal Sb.

The output of the queue buffers 11 and 12 are supplied to the operation code buses A and B via the changeover switch 13. The changeover signal Sa output by the central processing unit 1 is also input into the changeover switch 13, and based on the changeover signal Sa, the output from the queue buffers 11 and 12 are linked to operation code buses A and B, respectively, or to operation code buses B and A, respectively.

When the central processing unit 1 judges that the condition for branching for a conditional branch instruction is met, the changeover signal Sa switches from a high logic level (hereinafter “high”) to a low logic level (hereinafter “low”) or vice versa. Therefore, when the central processing unit 1 judges that the condition for branching for a conditional branch instruction is met, the changeover switch 13 reverses the connection of the queue buffers 11 and 12 with the operation code buses A and B. The queue selection signal Sb decides on which of the queue buffers 11 and 12 the data from the code bus is to be written, and depending on the status of the changeover signal Sa and the branch instruction detection signal Sc, decides either queue buffer 11 or 12 for the branch target code and non-branching code output to the code bus.

As shown in FIG. 2, the central processing unit 1 includes a control circuit section 20 and a data bus section 30. The data bus section 30 has a plurality of process stages for carrying out a pipeline process. In this example the pipeline process comprises three stages, namely ST0, ST1 and ST2. The first stage ST0 involves fetching and decoding an instruction, the second stage ST1 involves address generation and reading from memory, and the third stage ST2 involves calculation and writing to memory.

ST0_A and ST1_A are the first and second stages in the case when a sequential instruction without conditional branching is to be executed. ST0_B and ST1_B are the first and second stages in the case when executing a branch target instruction. A selector 31 is located between the second stage ST1 and the third stage ST2 and selects between the second stage in sequential path ST1_A and the second stage in branch target path ST1 _B for output to the third stage ST2. The selector 31 makes the selection based on the branch/non branch judgment signal Sd that comes from the control circuit section 20. The first stage in sequential path ST0_A is connected to the operation code bus A and the first stage in branch target path ST0_B is connected to the operation code bus B.

The data bus section 30 is controlled according to the control signal input from the control circuit section 20. One such signal is the branch/non branch judgment signal Sd that selects whether the data bus ST1_A or ST1_B is to be used for output from the second stage ST1 to the third stage ST2.

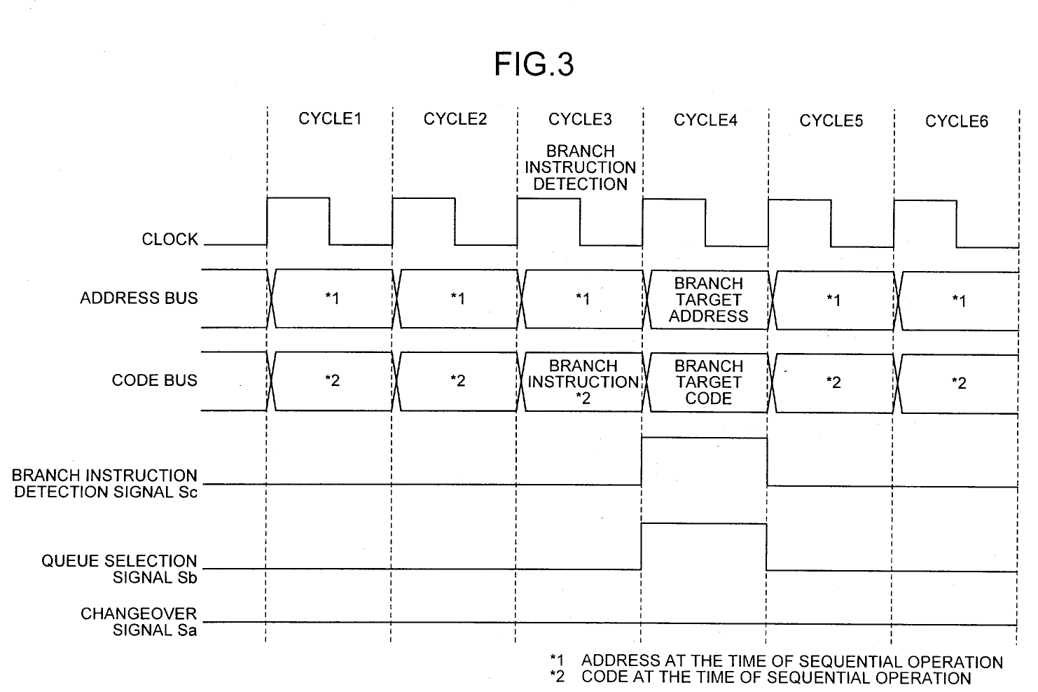

FIG. 3 is a time chart that explains the transaction between the code interface circuit 2 and the code memory area 4. In this example, a code that follows a sequential path is stored in the queue buffer 11 and a branch target code is stored in the queue buffer 12. Access of the code memory area 4 is carried out by clock synchronization and the number of access cycle is taken as 1.

In cycle 1 to cycle 3 the sequential code is prefetched. When the branch instruction detection signal Sc is “low”, the program counter in the address bus is incremented sequentially. Further when the queue selection signal Sb is “low”, the data in the code bus is written to the queue buffer 11.

Suppose a branch instruction is present in the code bus in cycle 3. In that case, the branch instruction detection/address creation circuit 10 detects the branch instruction, calculates the branch target address, and in the next cycle (cycle 4) outputs the branch target address. Further, in the same cycle (cycle 4), the branch instruction detection/address creation circuit 10 asserts the queue selection signal Sb as “high”. As a result, the branch target code in the code bus is taken into the queue buffer 12. From cycle 5 onward, prefetching of code that follows a sequential path is restored. Subsequently, the branch target instruction (the branch target code and the instructions that continue on to a branch target code) is written to the queue buffer 12. If once again a branch instruction is present among the instructions that continue on to the branch target code, the branch target instructions from this branch instruction are written to the queue buffer 11.

The code length that is taken into any one of the queue buffers 11 and 12 in one cycle period can correspond to the length of one instruction or a plurality of instructions. If the code length corresponds to the length of one instruction, when taking in a branch target code, the code following the branch target needs to be taken in over a plurality of cycles.

Thus, if the above setup is employed, the branch target instruction is prefetched before the conditional branch instruction is executed in the central processing unit 1.

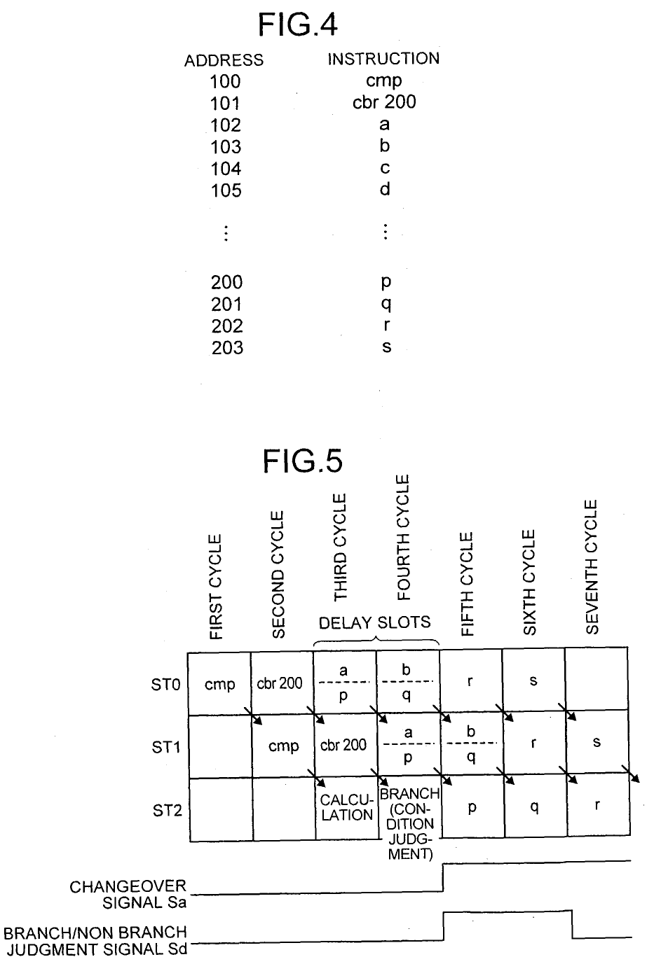

The operation of the central processing unit 1 is explained with reference to FIG. 4 to FIG. 6. FIG. 4 is a sample program in assembler language level that shows a case in which a conditional branch instruction immediately follows a calculate instruction that updates a condition flag. Address 100 has the calculate instruction cmp and address 101 has the condition branch instruction cbr 200 (which means that the path is routed to address 200 when the condition is met). Further, address 102 has an instruction ‘a’, address 103 has an instruction ‘b’, address 104 has an instruction c, address 105 has an instruction d, address 200 has in instruction ‘p’, address 201 has an instruction ‘q’, address 202 has an instruction ‘r’, and address 203 has an instruction ‘s’.

FIG. 5 shows the pipeline action when a branch condition of the conditional branch instruction is met when the program shown in FIG. 4 is executed. FIG. 5 also shows a change in the timing of the branch/non branch judgment signal Sd and the changeover signal Sa that is output to the code interface circuit 2.

An instance when the branch condition is met is explained next with reference to FIG. 1 through FIG. 5.

In the initial state, the changeover signal Sa and the branch/non branch judgment signal Sd are “low”. Consequently, the queue buffer 11 is connected to the operation code bus A and the queue buffer 12 is connected to the operation code bus B. The selector 31 selects ST1_A on the operation code bus A side for outputting to the third stage ST2.

In the first cycle, when the code interface circuit 2 feeds the instruction cmp (see FIG. 4) to the operation code bus A of FIG. 1, the central processing unit 1 sends the instruction cmp to the first stage in sequential path ST0_A. In the second cycle, when the code interface circuit 2 feeds the instruction cbr 200 to the operation code bus A, the instruction cbr 200 is input to the first stage in sequential path ST0_A. As the instruction cbr 200 is a branch instruction, the branch target codes are sent to the queue buffer 12 in the previous cycles. Consequently, the branch target codes (instruction ‘p’, instruction ‘q’, instruction ‘r’, . . . ) are fed to the operation code bus B.

In the third cycle, the central processing unit 1 sends the non branch target instruction ‘a’ that is output to the operation code bus A to the first stage in sequential path ST0_A and the branch target instruction ‘p’ that is output to the operation code bus B to the first stage in branch target path ST0_B. In the fourth cycle, the central processing unit 1 sends the non branch target instruction ‘b’ that is output to the operation code bus A to the first stage in sequential path ST0_A and the branch target instruction ‘q’ that is output to the operation code bus B to the first stage in branch target path ST0_B.

In the fourth cycle, in the third stage ST2 in the execution of cbr 200 if the control circuit section 20 judges that the condition of the branch instruction is met, in response, the control circuit section 20 asserts the changeover signal Sa and the branch/non branch judgment signal Sd to “high” in the next cycle, that is, the fifth cycle. The branch/non branch judgment signal Sd remains “high” during the cycle period (2 in this case) corresponding to N−1 cycles, where N is the number of process steps (in this case 3) of the data bus section 30. After that it is arranged that the branch/non branch judgment signal Sd returns to “low”. On the other hand, the changeover signal Sa continues to remain “high” until the next time the judgment that the condition of a branch instruction is being met is made.

Consequently, in the fifth cycle and the sixth cycle, the selector 31 selects the second stage in branch target path ST1_B for output to the third stage ST2. Consequently, in the fifth cycle, the instruction ‘p’ is sent to the third stage ST2, and in the sixth cycle, the instruction ‘q’ is sent to the third stage ST2.

At the point the changeover signal Sa that is input to the code interface circuit 2 becomes “high”, the changeover switch 13 changes over. That is, when the changeover signal S becomes “high”, the connections are switched so that the branch target instructions (r, s, . . . ) stored in the queue buffer 12 are output to the operation code bus A, and the non branch instructions stored in the queue buffer 11 are output to the operation code bus B. Consequently, in the fifth cycle, when the code interface circuit 2 feeds the instruction ‘r’ to the operation code bus A, the central processing unit 1 sends it to the first stage in sequential path ST0_A. In the sixth cycle, when the code interface circuit 2 feeds the instruction ‘s’ to the operation code bus A, the central processing unit 1 sends it to the first stage in sequential path ST0_A.

From the seventh cycle onwards, the branch/non branch judgment signal Sd changes to “low”. Hence the selector 31 selects the second stage in sequential path ST1_A for output to the third stage ST2. Consequently, in the seventh cycle, the instruction ‘r’ is sent to the third stage ST2, and in the eighth cycle, the instruction ‘s’ is sent to the third stage ST2.

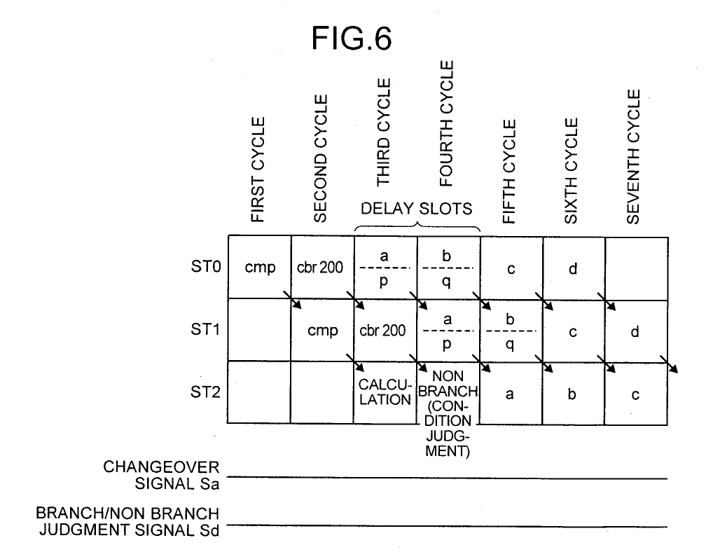

FIG. 6 shows the pipeline action when the branch condition of the conditional branch instruction is not met. FIG. 6 also shows a change in timing of the branch/non branch judgment signal Sd and the changeover signal Sa that is output to the code interface circuit 2.

An instance when the branch condition is not met is explained next with reference to FIG. 1 through FIG. 4 and FIG. 6.

In the initial state, the changeover signal Sa and the branch/non branch judgment signal Sd are “low”. Consequently, the queue buffer 11 is connected to the operation code bus A and the queue buffer 12 is connected to the operation code bus B. The selector 31 selects ST1_A on the operation code bus A side for output to the third stage ST2.

In the first cycle, when the code interface circuit 2 feeds the instruction cmp (see FIG. 4) to the operation code bus A, the central processing unit 1 sends the instruction cmp to the first stage in sequential path ST0_A. In the second cycle, when the code interface circuit 2 feeds the instruction cbr 200 to the operation code bus A, the instruction cbr200 is sent to the first stage in sequential path ST0_A. As the instruction cbr 200 is a branch instruction, the branch target codes are sent to the queue buffer 12 in the previous cycles. Consequently, branch target codes (instruction p, instruction q, instruction r, . . . ) are fed to the operation code bus B.

In the third cycle, the central processing unit 1 sends the non branch target instruction ‘a’ that is output to the operation code bus A to the first stage in sequential path ST0_A and the branch target instruction ‘p’ that is output to the operation code bus B to the first stage in branch target path ST0_B. In the fourth cycle, the central processing unit 1 sends the non branch target instruction ‘b’ that is output to the operation code bus A to the first stage in sequential path ST0_A and the branch target instruction ‘q’ that is output to the operation code bus B to the first stage in branch target path ST0_B.

Let us suppose that in the fourth cycle, in the third stage ST2 in the execution of cbr200 the control circuit section 20 of the central processing unit 1 judges that the condition of the branch instruction is not met. Consequently, the changeover signal Sa and the branch/non branch judgment signal Sd output from the control circuit section 20 of the central processing unit 1 remain “low”.

Consequently, from the fifth cycle onwards, the selector 31 selects the second stage in sequential path ST1_A for output to the third stage ST2. Consequently, in the fifth cycle the instruction ‘a’ is sent to the third stage ST2, and in the sixth cycle the instruction ‘b’ is sent to the third stage ST2.

As the changeover signal Sa remains “low” from the fifth cycle onwards, the connections are maintained as before. That is, the queue buffer 11 is connected to the operation code bus A and the queue buffer 12 is connected to the operation code bus B. Consequently, in the fifth cycle, when the code interface circuit 2 feeds the instruction ‘c’ to the operation code bus A, the central processing unit 1 sends the instruction ‘c’ to the first stage in sequential path ST0_A. In the sixth cycle, when the code interface circuit 2 feeds instruction ‘d’ to the operation code bus A, the central processing unit 1 sends the instruction ‘d’ to the first stage in sequential path ST0_A.

Further, as the branch/non branch judgment signal Sd remains ‘low’ from the seventh cycle onwards, the selector 31 selects the second stage in sequential path ST1_A for output to the third stage ST2. Consequently, in the seventh cycle, the instruction ‘c’ is sent to the third stage ST2, and in the eighth cycle, the instruction ‘d’ is sent to the third stage ST2.

As the changeover signal Sa remains “low” from the fifth cycle onwards, as before, the queue buffer 11 remains connected to the operation code bus A and the queue buffer 12 remains connected to the operation code bus B. Consequently, in the fifth cycle, when the code interface circuit 2 sends the instruction ‘c’ to the operation code bus A, the central processing unit 1 feeds the instruction ‘c’ to the first stage in sequential path ST0_A. In the sixth cycle, when the code interface circuit 2 feeds the instruction ‘d’ to the operation code bus A, the central processing unit 1 sends the instruction ‘d’ to the first stage in sequential path ST0_A.

Further, as the branch/non branch judgment signal Sd remains “low’ from the seventh cycle onwards, the selector 31 selects the second stage in sequential path ST1_A for output to the third stage ST2. Consequently, in the seventh cycle the instruction ‘c’ is sent to the third stage ST2, and in the eighth cycle the instruction ‘d’ is sent to the third stage ST2.

Thus, in the first embodiment the need for a built-in branch predicting circuit is obviated by providing two types of queue buffers 11 and 12, one for storing prefetched non branch instructions and the other for storing prefetched branch target instructions, a multi-stage pipeline process, and two paths of pipeline process stages (data bus section 30) in all the stages except the last stage. The delay slot in the pipeline is utilized effectively by judging whether the branch condition is met and accordingly switching the changeover control so as to send the instruction in process stages in either of the two paths to the last stage. The net effect is improved functionality of the central processing unit.

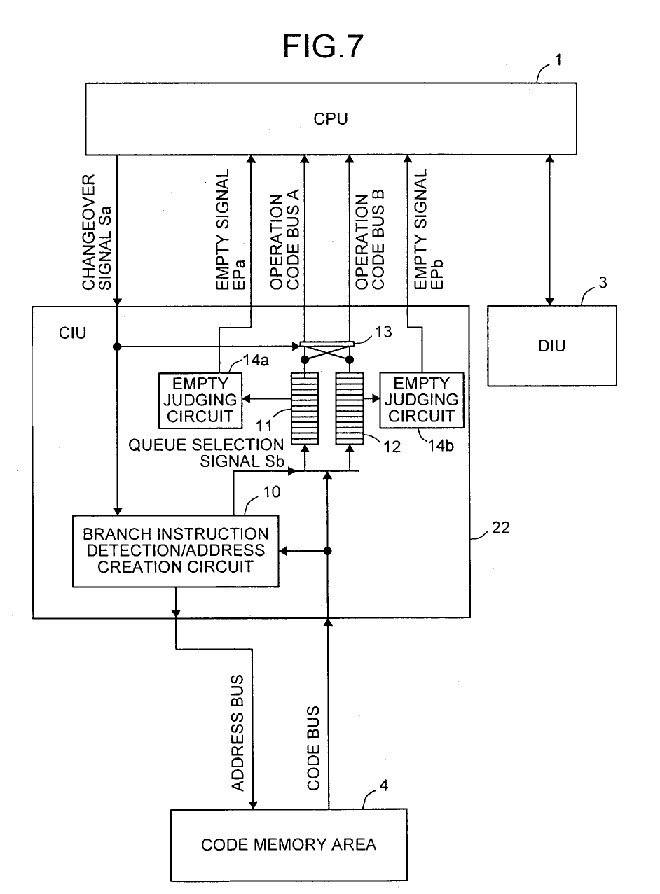

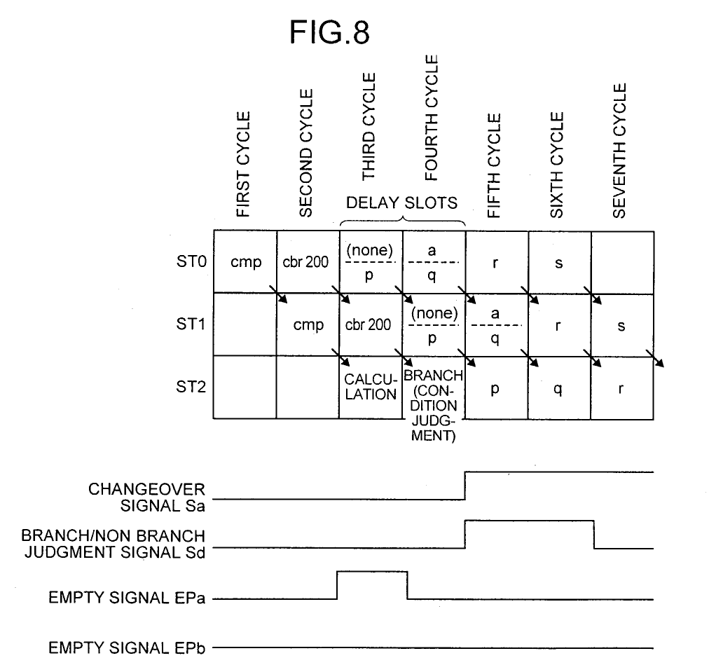

A second embodiment of the present invention is explained next with reference to FIG. 7 and FIG. 8. FIG. 7 is a schematic diagram of a microprocessor according to the second embodiment. In this embodiment, empty judging circuits 14a and 14b that judge whether or not the queue buffers 11 and 12 are empty are provided in a code interface circuit 22. When the queue buffer 11 becomes empty, the empty buffer 14a outputs empty signal EPa to the central processing unit 1. When the queue buffer 12 becomes empty, the empty buffer 14b outputs empty signal EPb to the central processing unit 1. All the other components are same as those shown in FIG. 1 so their description is omitted to avoid simple repetition of explanation.

An instance of when no non branch target codes are lined up in the queue buffer 11 during relay to delay slot and when a branch condition is not met is explained next with reference to FIG. 7 and FIG. 8. The sample program explained with respect to FIG. 4 is used for this purpose.

The sequence of steps that leads up to the relay of the instruction cbr 200 (second step) is the same as explained with reference to FIG. 5 and hence is not described here.

Ordinarily, in the third cycle, the central processing unit 1 sends the non branch target instruction ‘a’ output to the operation code bus A to the first stage in sequential path ST0_A and the branch target instruction ‘p’ output to the operation code bus B to the first stage in branch path ST0_B. However, since the instruction cbr200 is a branch instruction, and the empty signal EPa is asserted as “high”, nothing is sent to the first stage in sequential path ST0_A and the instruction ‘p’ is sent to the first stage in branch path ST0_B.

In the fourth cycle, empty signal EPa is negated as “low” as the non branch target instruction ‘a’ is stored in the queue buffer 11. The code interface circuit 2 feeds the non branch target instruction ‘a’ to the operation code bus A, and the branch target instruction ‘q’ to the operation code bus B. The central processing unit 1 sends the instructions ‘a’ and ‘q’ to the first stage in sequential path ST0_A and the first stage in branch path ST0_B.

Further, in the fourth cycle, in the third stage ST2, i.e., in the execution stage of the instruction cbr 200, if the control circuit section 20 judges that the condition of branch instruction is met, the control circuit section 20, in response, asserts the changeover signal Sa and the branch/non branch judgment signal Sd as “high” in the next cycle (the fifth cycle in this case).

Consequently, in the fifth and sixth cycle, the selector 31 selects the second stage in branch path ST1_B for output to the third stage ST2. Consequently, in the fifth cycle, the instruction ‘p’ is sent to the third stage ST2, and in the sixth cycle, the instruction ‘q’ is sent to the third stage ST2.

At the point the changeover signal Sa that is input to the code interface circuit 22 becomes “high”, the changeover switch 13 changes over. That is, when the changeover signal Sa becomes “high”, the connections are switched so that the branch target instructions (r, s, . . . ) stored in the queue buffer 12 are output to the operation code bus A, and the non branch instructions stored in the queue buffer 11 are output to the operation code bus B. Consequently, in the fifth cycle, when the code interface circuit 22 feeds the instruction ‘r’ to the operation code bus A, the central processing unit 1 sends it to the first stage in sequential path ST0_A. In the sixth cycle, when the code interface circuit 22 feeds the instruction ‘s’ to the operation code bus A, the central processing unit 1 sends it to the first stage in sequential path ST0_A.

Further, from the seventh cycle onwards, the branch/non branch judgment signal Sd changes to “low”. Hence the selector 31 selects the second stage in sequential path ST1_A for output to the third stage ST2. Consequently, in the seventh cycle, the instruction ‘r’ is sent to the third stage ST2, and in the eighth cycle, the instruction ‘s’ is sent to the third stage ST2.

Thus, according to the second embodiment, the code interface circuit 22 inputs empty signals EPa and EPb (i.e., signals that indicate that the queue buffers 11 and 12 are empty) into central processing unit 1. Therefore, in the pipeline process, even if both branch target codes and non branch target codes do not exist at the same time, the process is not stalled and the relay of instruction is carried out independently. As a result, functionality of the central processing unit is improved.

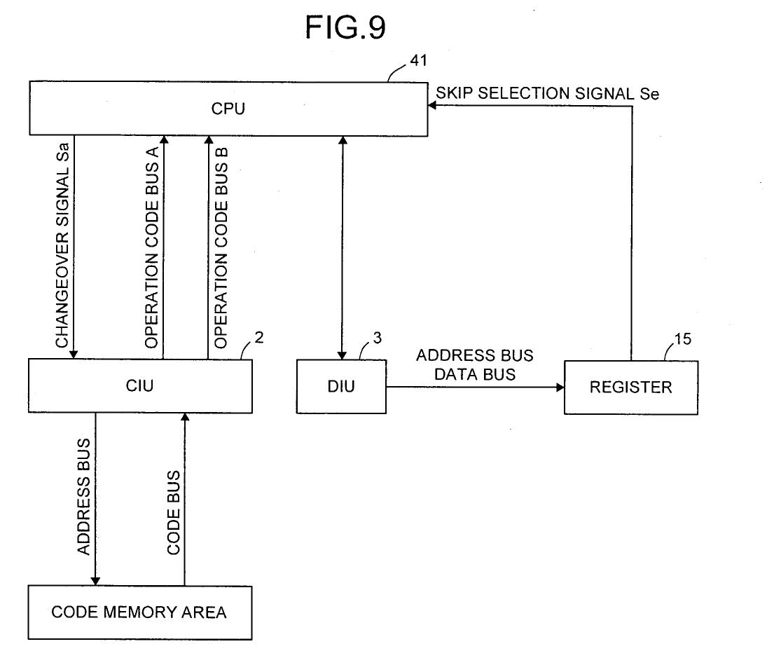

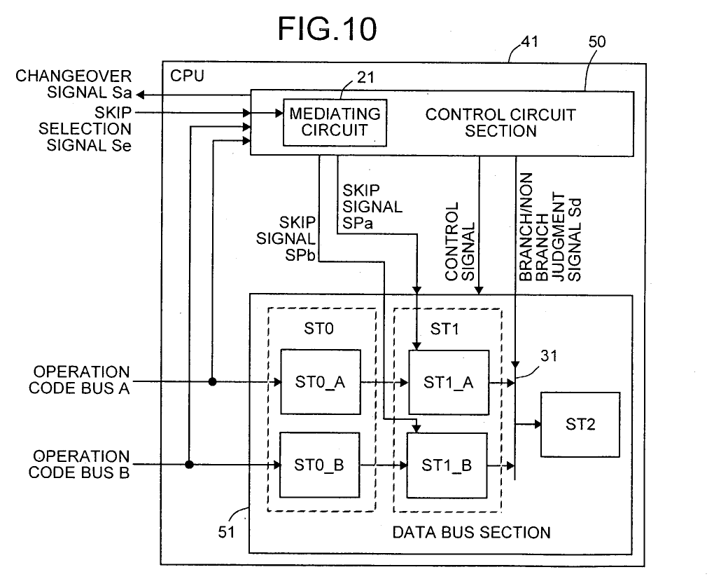

A third embodiment of the present invention is explained next with reference to FIG. 9 to FIG. 11. FIG. 9 is a schematic diagram of a microprocessor according to the third embodiment. FIG. 10 is a schematic diagram of a central processing unit 41 employed in the microprocessor according to the third embodiment.

In the third embodiment, the central processing unit 41 judges if, in the branch target instruction and the non branch target instruction that is sent to the delay slot, there is any competition of data resource arising out of data being read from the same data area. If there is competition, the central processing unit 41 selects either the branch target instruction or the non branch target instruction.

In the third embodiment, as shown in FIG. 9, a register 15, in which a register value is set, is additionally connected via the data interface circuit 3. The register value of the register 15 can be overwritten according to the software and is output to the central processing unit 41 as a skip selection signal Se. The central processing unit 41 is able to write/read the value of the register 15, also known as the skip selection signal Se, via the data interface circuit 3.

As shown in FIG. 10, a mediating circuit 21 is provided in a control circuit section 50 of the central processing unit 1. Reference numeral 51 indicates a data bus section according to the third embodiment. The mediating circuit 21 judges if any competition arises between the branch target instruction and non branch target instruction for filling a delay slot. If there is competition, the mediating circuit 21 asserts any one of skip signals SPa and SPb, based on the input skip selection signal Se. If the skip signal SPa is asserted, the second stage in sequential path ST0_A is skipped. If the skip signal SPb is asserted, the second stage in branch path ST0_B is skipped. In other words, when competition arises in the second stage ST1—the stage in which address creation and memory reading is executed—since both the processes cannot be carried out simultaneously, one of them is skipped. Further, if the skip selection signal Se is “low”, the skip signal SPa is asserted and non branch target instruction is skipped, and if the skip selection signal Se is “high”, the skip signal SPb is asserted and the branch target instruction is skipped.

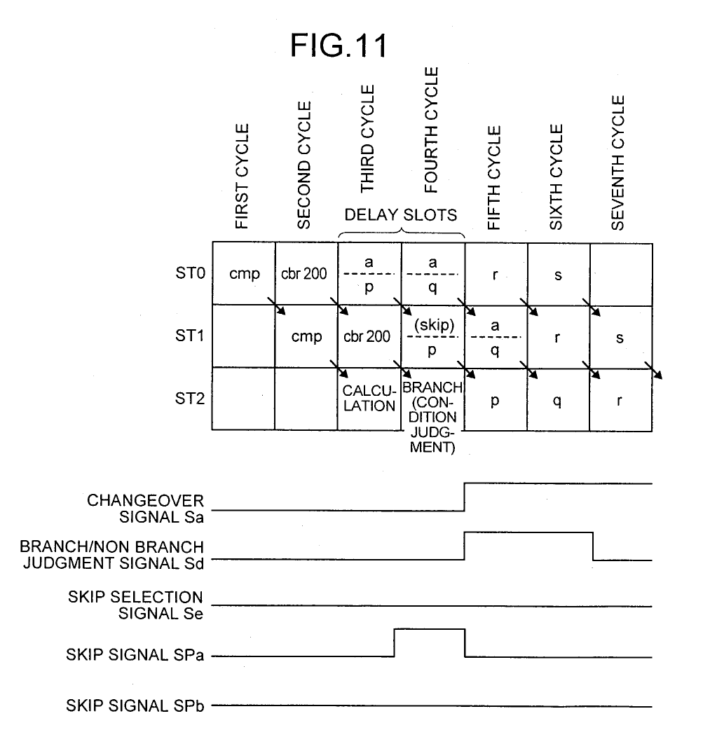

An instance when there is competition between branch target instruction and non branch target instruction for filling the delay slot and when the branch condition is met with reference to FIG. 11. The sample program shown in FIG. 4 is used for this purpose.

The sequence of steps that lead up to the cycle (second cycle) in which the branch target instruction and the non branch target instruction are sent to the first delay slot are same as those described in the first embodiment and the second embodiment and hence is not described here.

In the third cycle, the non branch target instruction ‘a’ is sent to the first stage in sequential path ST0_A and the branch target instruction ‘p’ is sent to the first stage in branch path ST0_B. The central processing unit 1 then judges if the two instructions are competing. If there is competition, the central processing unit 1 refers to the skip selection signal Se and, based on the skip selection signal Se, skips sending one of the instructions to the second stage. In this case, as the skip selection signal S3 is “low”, the skip signal SPa is asserted as “high”. As a result, in the fourth cycle, the non branch target instruction is skipped from being sent to the second stage ST1_A.

Further, in the fourth cycle, the non branch target instruction ‘a’ and the branch target instruction ‘q’ are judged for competition. Since there is no competition, in the fifth cycle, no skipping occurs and these two instructions are sent to the second stage. The rest of the sequence of steps is the same as the one explained with reference to FIG. 5 and hence is not described here.

Thus, in the third embodiment, the functionality of the central processing unit is improved even if competition exists, by skipping the processing of either the branch target instruction or the non branch target instruction and sending only one of them to a delay slot. Further, it is possible to select what is to be skipped using a software. Hence, if the frequency at which branch condition of a branch instruction is met is already known, programming can be done in such a way that every time the right branch is chosen and the path that has low frequency is skipped. This shortens the overall execution time of a program.

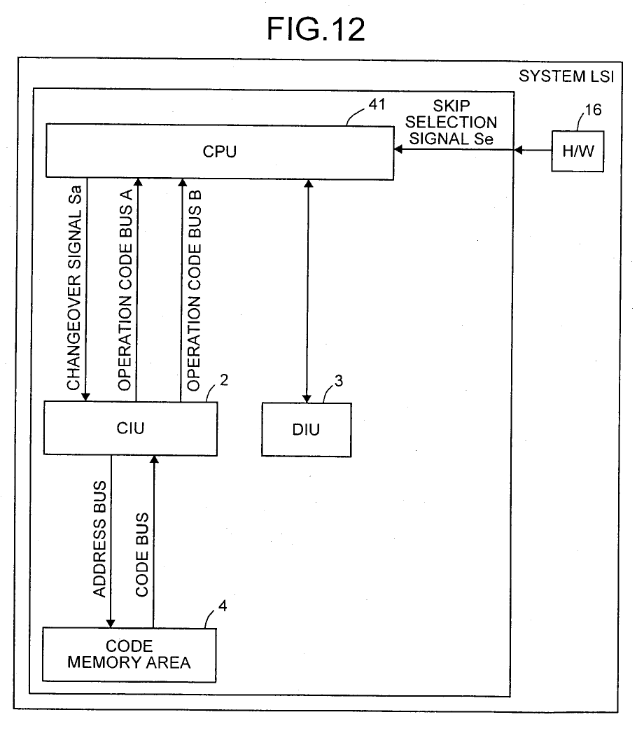

A fourth embodiment of the present invention is explained next with reference to FIG. 12. FIG. 12 is a schematic diagram of a microprocessor according to the fourth embodiment.

In the fourth embodiment, a microprocessor is built into a system LS1. The skip selection signal Se is input into the central processing unit 41 of the microprocessor from an external hardware (H/W) 16 of the microprocessor. The rest of the structure is identical to the third embodiment of the present invention.

In the system LS1 with the built-in microprocessor, the signal that determines whether a branch condition is met is present in the external hardware 16 of the microprocessor. In the third embodiment the skip selection signal Se is input into the central processing unit 41 from the register 15 while in the fourth embodiment the skip selection signal Se is input into the central processing unit 41 from the hardware 15.

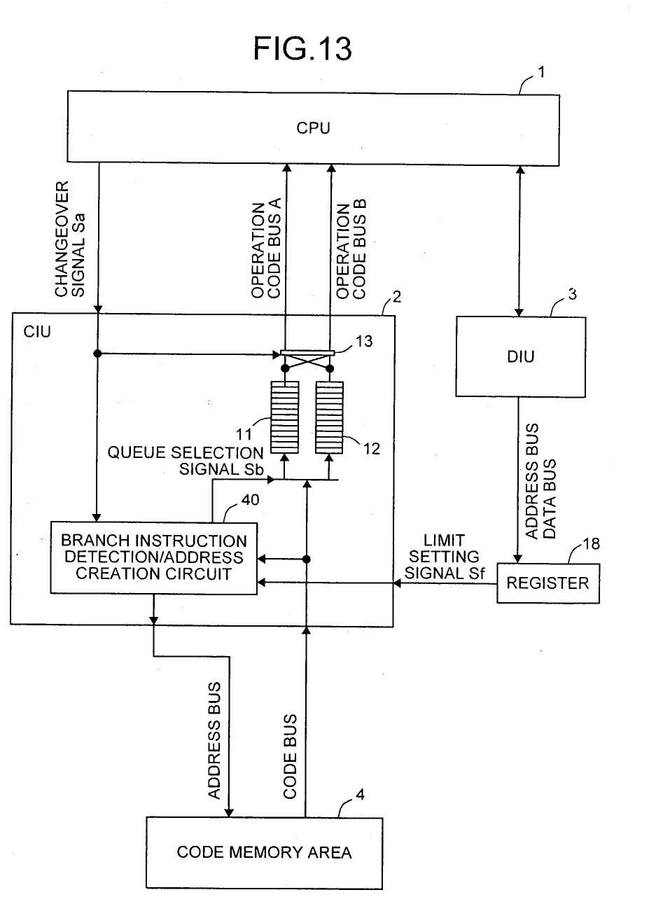

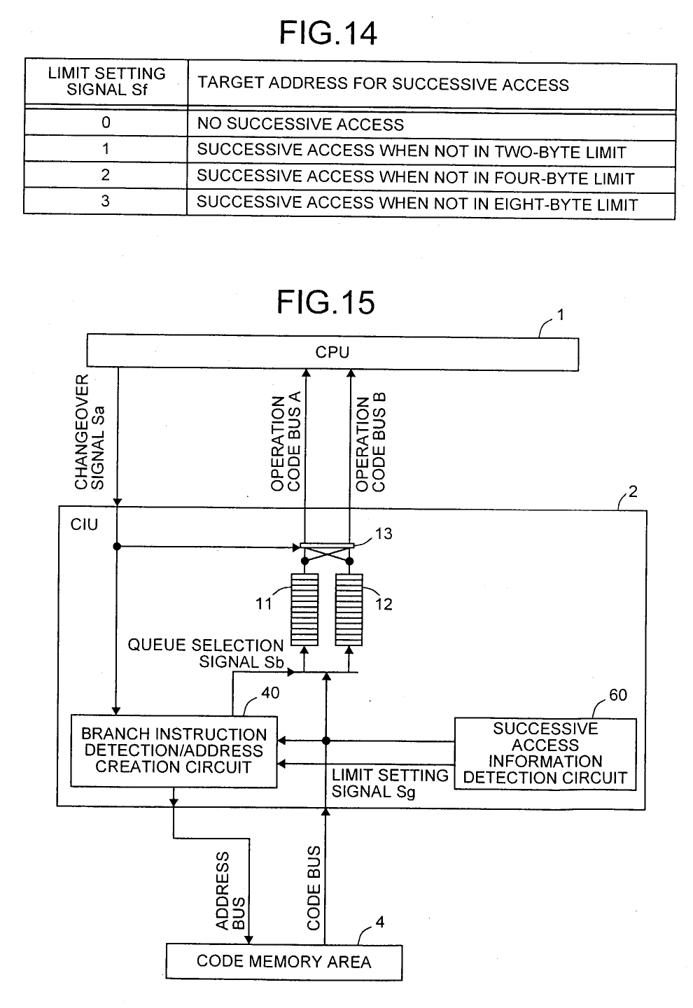

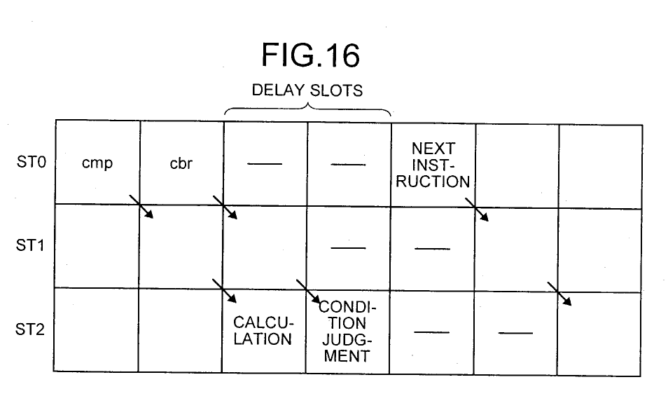

A fifth embodiment of the present invention is explained next with reference to FIG. 13 and FIG. 14.

In the microprocessor according to the fifth embodiment, a register 18, in which a register value is set, is connected to the central processing unit 1 via the data interface circuit 3. The register value of the register 18 can be overwritten according to the software and is output to the central processing unit 1 as skip selection signal Se. The central processing unit 1 is able to write/read the value of the register 18, also known as the skip selection signal Se, via the data interface circuit 3.

The register 18, for instance, is set with a two-bit limit setting signal Sf as shown in FIG. 14. When a branch instruction detection/address creation circuit 40 accesses the code memory area 4 to read the instruction codes, the limit setting signal Sf specifies whether or not the instruction codes are to be read by successive access. For instance, if the branch instruction detection/address creation circuit 40 reads one byte at a time, and the length of the branch target instruction (code length) is two bytes, the limit setting signal Sf enables successive access.

As shown in FIG. 14, when the limit setting signal Sf is 0, successive access does not take place. When the limit setting signal Sf is 1, successive access takes place when the branch target code is not in the two-byte limit. When the limit setting signal Sf is 2, successive access takes place when the branch target code is not in the four-byte limit. When the limit setting signal Sf is 3, successive access takes place when the branch target code is not in the eight-byte limit.

The branch instruction detection/address creation circuit 40 creates a branch target address when it detects a new branch instruction on the code bus. The branch instruction detection/address creation circuit 40, based on the value of limit setting signal Sf and the value of the created branch target address, judges if the branch target codes are to be prefetched successively or not. The branch instruction detection/address creation circuit 40, then, based on the result of judgment, either prefetches or does not prefetch branch target codes successively.

Thus, in the fifth embodiment, judging whether or not to prefetch branch target codes is performed based on the value of the limit setting signal Sf and the value of the created branch target address. As surplus branch target codes can be prefetched beforehand, there is no wastage of time when actually sending instructions to various stages of the pipeline process even if the prefetched code does not qualify as a branch target instruction (for instance, in case of long instructions). Consequently, there is improved CPU functionality.

In a sixth embodiment of the present invention, the information (successive retrieval information) relating to whether to prefetch branch target code successively or not is included in the branch instruction codes.

When creating a memory table by a program using a compiler or an assembler, it can be retrieved using some retrieval tool and based on address information that is mapped in the memory as the lengths of the target codes and the codes itself, whether it is necessary to access the code successively. Based on the result of the retrieval the successive retrieval information, shown in FIG. 4, that is optimum for can be set in each branch instruction, so that the same effects as those achieved in the fifth embodiment can be achieved without being conscious at the time of writing the program whether or not target codes are to be accessed. Further, in this case the register 18 shown in the fifth embodiment is not required. Consequently, the value of the register 18 need not be overwritten on the program. Therefore, the code memory area 4 can be reduced.

A seventh embodiment of the present invention is explained with reference to FIG. 15. FIG. 15 is a schematic diagram of a microprocessor according to the seventh embodiment.

In the seventh embodiment, the information on whether successive retrieval of code when prefetching frequently occurring branch target code is required is included in the code. As shown in FIG. 15, in the seventh embodiment, a successive retrieval information detection circuit 60 is provided in the code interface circuit 2. The successive retrieval information detection circuit 60 detects if there are branch instructions that include the successive retrieval information on the code bus. On detecting a branch instruction that includes the successive retrieval information, the successive retrieval information detection circuit 60 extracts the successive retrieval information and keeps it until it comes across the next branch instruction that includes the successive retrieval information. The successive retrieval information detection circuit 60 then outputs the information to the branch instruction detection/address creation circuit 40 as a limit setting signal Sg. The branch instruction detection/address creation circuit 40 has the same operation as that in the sixth embodiment.

In the seventh embodiment, the need for including the successive retrieval information in all the branch instructions is obviated. Therefore, apart from the effects achieved in the fifth embodiment and the sixth embodiment, the efficiency of the code memory area 4 is also vastly improved.

In an eighth embodiment of the present invention, a circuit is built into the code interface circuit 2 in the fifth, sixth and seventh embodiment such that the access method, adopted for accessing the code memory area 4 for successive retrieval in order to prefetch branch target code, is a burst access method. In this type of structure the number of access cycles required for accessing code memory area 4 can be considerably reduced. Therefore, the execution time of the program itself can be shortened.

According to the present invention, the microprocessor is provided with two types of queue buffers, one for storing prefetched non branch instructions and the other for storing prefetched branch target instructions, and a pipeline process that have a plurality of stages. Further, in the stages other than the last stage, there are two systems of pipeline process that follow two different paths, one for processing non branch instructions and the other branch target instructions. A control is provided for switching between the two paths based on the judgment signal indicating whether branch condition is met or not. Consequently, the need for a branch predicting circuit is obviated. Also, the delay slots in the pipeline stages are effectively utilized, thereby improving the CPU functionality.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A microprocessor comprising:
a memory for storing instructions;
a first queue buffer and a second queue buffer, wherein the first queue buffer stores non branch instructions from among the instructions prefetched from the memory and the second queue buffer stores branch target instructions from among the instructions prefetched from the memory;
a plurality of process stages that perform pipeline processing, wherein the process stages prior to a last process stage being arranged in a first path and a second path;
a first changeover unit that judges if a branch condition of a branch instruction is met or not and, based on the judgment outcome selects any one of the first path and the second path for pouring the contents to the last process stage;
a second changeover unit that, based on the judgment outcome, switches the connection of the first queue buffer and the second queue buffer with the first path and the second path.

2. The microprocessor according to claim 1, further comprising a third changeover unit that detects the presence of a branch instruction on a bus that connects the memory to the first queue buffer and the second queue buffer, and, based on the judgment outcome and detection outcome, switches the allocation of non branch instruction and branch target instruction to the first queue buffer and the second queue buffer.

3. The microprocessor according to claim 1, further comprising an empty detection unit that detects if any of the first queue buffer and the second queue buffer is empty, and, individually skips pouring of the branch target instruction and the non branch instruction in the processing stages based on the detection outcome.

4. The microprocessor according to claim 1, wherein it is judged if there is competition between the branch target instruction and the non branch instruction that are processed in the process stages in the first path and the second path respectively, and, based on the judgment outcome, processing of any one of the branch target instruction and the non branch instruction is skipped.

5. The microprocessor according to claim 1, wherein when prefetching branch target instructions from the memory, prefetching of the branch target instructions is performed successively if the branch target instructions are not in a specific byte limit set for branch target instructions.

6. The microprocessor according to claim 1, wherein successive access information, that indicates whether successive access is required or not, is included in the branch target instructions, and the decision as to whether successive prefetching of a branch instruction is to be carried out is taken based on the detection of the successive access information.
